(19) United States
(12) Patent Application Publication
(10) Pub. No.: US 2024/0269499 A1
(43) Pub. Date: Aug. 15, 2024

(54) EXTINGUISHING SYSTEM AND METHOD FOR OPERATING SUCH A SYSTEM

(71) Applicant: MECON GmbH, Overath (DE)

(72) Inventors: Joachim Böke, Düsseldorf (DE); Stephan Bludau, Elmenhorst (DE)

(21) Appl. No.: 18/439,075

(22) Filed: Feb. 12, 2024

(30) Foreign Application Priority Data
Feb. 15, 2023 (DE) 102023103637.8
Jan. 15, 2024 (DE) 102024101000.2

(51) Int. Cl. A62C 37/50; A62C 37/36

(52) U.S. Cl. CPC A62C 37/50; A62C 37/36

(57) ABSTRACT

A water extinguishing system has an extinguishing fluid supply adapted to provide an extinguishing fluid, at least one pump adapted to convey the extinguishing fluid from the extinguishing fluid supply into a supply line to a pipe system of the water extinguishing system, and a control unit adapted to operate the at least one pump in a controllable manner. The control unit is configured to start and to operate the pump for a pump test run on provision of a start signal and to end the pump test run and to stop the pump on provision of a stop signal. The control unit has a signal suppression unit which is adapted to at least temporarily suppress the provision of the stop signal in the event of a fire. The signal suppression unit is configured to be free of executing a computer program. A corresponding method operates a water extinguishing system.

### CROSS-REFERENCE TO RELATED APPLICATION

This application claims priority to German Patent Application No. 102023103637.8, filed Feb. 15, 2023 and German Patent Application No. 102024101000.2, filed Jan. 15, 2024, which both are hereby incorporated by reference in their entirety.

### FIELD OF THE INVENTION

The present invention relates to a water extinguishing system, comprising an extinguishing fluid supply adapted to provide an extinguishing fluid, at least one pump adapted to convey the extinguishing fluid from the extinguishing fluid supply into a supply line to the pipe system of the water extinguishing system, a control unit adapted to operate the at least one pump in a controllable manner, which control unit is configured to start and to operate the pump for a pump test run on provision of a start signal and to end the pump test run and to stop the pump on provision of a stop signal.

The invention relates further to a method for operating a water extinguishing system having an extinguishing fluid supply adapted to provide an extinguishing fluid, at least one pump adapted to convey the extinguishing fluid from the extinguishing fluid supply into a supply line to the pipe system of the water extinguishing system, and a control unit adapted to operate the at least one pump in a controllable manner, which control unit is configured to start and to operate the pump for a pump test run on provision of a start signal and to end the pump test run and to stop the pump on provision of a stop signal, which method comprises the following steps: starting and operating the pump for the purposes of the pump test run by means of the control unit when a start signal is provided, ending the pump test run and stopping operation of the pump in the case where a stop signal is provided.

### BACKGROUND OF THE INVENTION

Such water extinguishing systems or sprinkler systems are used in firefighting. In the event of a fire, a pump is preferably started, which conveys an extinguishing fluid to the nozzles or sprinklers. Water or water with extinguishing agent additives, such as, for example, foam or wetting agents, is used as the extinguishing fluid. Therefore, water extinguishing systems are here understood as being all extinguishing systems which are operated by means of an extinguishing agent in fluid form. In practice, such water extinguishing systems generally comprise pressure switch apparatuses, which are configured, for example, as pressure switches. Such pressure switches generate a switch signal in the event of a pressure drop, at a predefined or predetermined threshold value. This switch signal can be used, for example, to initiate further operations, for example to start a pump or a plurality of pumps as mentioned. The switch signal can also be supplied in the form of a warning signal for a pressure drop to a central control unit for further processing.

In water extinguishing systems, in particular sprinkler systems, a nozzle or sprinkler opens in the event of a fire, so that an extinguishing fluid, preferably water or water with fire-inhibiting additives, can be delivered to fight the fire. In water extinguishing systems with open nozzles, an alarm valve opens in order to effect the provision of the extinguishing fluid to the nozzles or sprinklers. The alarm valve is activated, for example, by way of a fire alarm centre. As a result of the opening of a sprinkler or nozzle, a pressure drop occurs in the pipe system carrying the extinguishing fluid. Such pressure switch apparatuses, in particular for sprinkler pumps, are subject inter alia to national standards and guidelines, for example VdS CEA 4001 2000-04:2021-01 (07).

The guideline provides in particular that at least one pressure switch is provided for starting each pump. It is also possible that two such pressure switches are connected electrically in series. Standards EN 12845:2020-11 and EN 5 12845:2015+A1:2019 are also important here. In order to maintain the operational availability of such extinguishing systems, regular checks and maintenance are required. Thus, guideline VdS 2212, for example, describes weekly checks of the water extinguishing system by the system operator.

Because the reliable start of the pump for conveying the extinguishing fluid is essential for the functioning of the extinguishing system, the tests also include a check of the pump start of the pump. For example, according to the guidelines of FM Global or the NFPA, a monthly test run is required in the case of electrically operated pumps and a weekly pump test run is required for diesel pumps. According to VdS CEA 4001 and EN 12845, a weekly pump test run is also required for electric pumps. Such pump test runs serve to check the functional capability of the entire chain of components in their interaction, from the generation of a pressure drop, the correct functional capability of the pressure switch apparatus to starting of the pump or pumps.

In practice, a pressure switch apparatus is provided for that purpose in such water extinguishing systems, which pressure switch apparatus has two pressure switches connected in series as pressure detecting devices. Alternatively, two pressure switch apparatuses are connected in parallel and are adapted such that they work as electrical closers. Both pressure switches must be tested for functional capability in such a pump test run. It is necessary to check the provision of the switch signal at the predetermined threshold value of the pressure for both pressure switches and starting of the pump by switch signal initiation.

Such a pressure switch apparatus known from the prior art can be considered part of a pump test device which comprises the mentioned central control unit, in particular a pump switch cabinet, a sprinkler pump switch cabinet or a combination of a fire alarm centre and a pump switch cabinet. The pump test device is adapted to start the pump on generation of a predefined pressure drop.

The pressure switches of the pressure switch apparatus are provided with a supply line to a main line which guides the extinguishing fluid from the pump outlet to the pipe system with the nozzles or sprinklers. The supply line establishes a fluid-carrying connection from the main line to the two pressure switches connected in series. Optionally it is divided into a first supply line to a first pressure switch and a second supply line to a second pressure switch. In the prior art, the supply line has, for example, shut-off valves, preferably in the form of a first shut-off valve and a second shut-off valve, and also valves for discharging extinguishing fluid in order to generate the necessary pressure drop for starting the sprinkler pump, and pressure gauges.

According to the prior art, the weekly test run of the pump is carried out manually by a trained person. It is thus in any case necessary according to the prior art published in standards and guidelines for trained personnel to be present on site during such a test run.

Such a pump test run known from the prior art is carried out, for example in the case of water extinguishing systems equipped with two of the pressure switches, as follows: a first shut-off valve in the first supply line is operated manually so that the fluid-carrying connection from the main line to the first pressure switch is interrupted so that, when a pressure drop is generated for the test run, the first pressure switch does not detect that pressure drop and thus cannot generate a switch signal. In this manner, exclusively the functioning of the second pressure switch and of the downstream components is tested. Where a pressure switch or pressure sensor is present, the start can be effected by means of a ⅔-way solenoid valve, activated by the “pump controller”.

The valve in the second supply line is then opened manually in order to generate a pressure drop. The second pressure switch then generates a switch signal at the generated pressure drop, at a specific switch pressure measured value, which is read off by the maintenance personnel at the pressure gauge, which switch signal is sent via a signal-carrying connection to the central control unit for starting the pump. The pump is started, and in practice the test run is ended when the normal operating characteristics of the pump have been reached.

The test run is then carried out with the pump being started by the first pressure switch. To that end, a second shut-off valve in the second supply line is operated manually so that the fluid-carrying connection from the main line to the second pressure switch is interrupted, so that, when a pressure drop is generated for the test run, the second pressure switch does not detect that pressure drop and cannot generate a switch signal. The valve in the first supply line is then opened manually in order to generate a pressure drop. The first pressure switch then generates a switch signal at the generated pressure drop, at a specific switch pressure measured value, which is read off by the maintenance personnel at the pressure gauge, which switch signal is sent via a signal-carrying connection to the central control unit for starting the pump.

The switch pressure measured values of the two pressure switches thus detected are then compared by the maintenance personnel with the predefined threshold values of the pressure switches in order to establish whether the detected values measured for the switch pressure correspond to the predefined threshold values within the permitted or specified tolerance.

Alternatively, known water extinguishing systems are also equipped with only one pressure switch. The pump test run is carried out in principle as described above, but only with the first pressure switch described there.

It is a disadvantage of the known water extinguishing systems and of the mentioned known method that the pump test run must in each case be carried out manually. In particular, it is necessary that a correspondingly trained person is present on site during such a pump test run in order to monitor the parameters. The performance of such a pump test run is therefore very personnel-intensive. If a fire event occurs during a pump test run, there is additionally a risk, in particular in the case of an automated system, that the pump will be stopped at the end of the pump test run when the stop signal is provided. During the performance of such a pump test run, there is therefore the problem that, despite the occurrence of a fire, the pump is stopped and the supply of extinguishing agent is interrupted in an inadmissible and dangerous manner.

### SUMMARY OF THE INVENTION

Accordingly, the object of the present invention is to propose a water extinguishing system which always ensures reliable provision of the extinguishing agent supply. In addition, it is an object of the present invention to propose a water extinguishing system by means of which a pump test run is ensured automatically while always ensuring that the extinguishing agent is supplied in the event of a fire. A further object is to propose a corresponding method.

The object is achieved by a water extinguishing system having the features mentioned at the beginning in that the control unit has a signal suppression unit which is adapted to at least temporarily suppress the provision of the stop signal in the event of a fire, and the signal suppression unit is configured to be free of executing a computer program. For the purposes of the present invention, being free of executing a computer program means that the signal suppression unit is not computer-controlled. In other words, it does not comprise a programmable controller by means of which a computer program is executed. Rather, the signal suppression unit comprises only electrical and/or electronic components which are not programmable. In this manner it is ensured that switching off of the pump is always prevented in the event of a fire. In other words, the control unit according to the invention is configured as a priority circuit which suppresses the provision of the stop signal in the event of a fire. It is thus ensured that, if a fire event occurs during a pump test run, a reliable extinguishing agent supply is always ensured. This for the first time makes it possible to carry out a pump test run largely automatically. The control unit according to the invention is preferably adapted such that the suppression of the provision of the stop signal is suppressed at least during the pump test run. Further preferably, the control unit is adapted to suppress the provision of the stop signal for a given blocking time, which extends beyond the duration of the actual pump test run. In this manner, high reliability and continuous functionality of the signal suppression unit are additionally ensured. To that end, signal suppression is preferably effected by means of analogue or digital circuits. Further preferably, suppression is carried out in a hard-wired manner by means of relay or protection combinations.

Alternatively, the object is also achieved by a water extinguishing system having the features mentioned at the beginning in that the control unit has a signal suppression unit which is adapted to at least temporarily suppress the provision of the stop signal in the event of a fire. In this manner it is ensured that switching off of the pump is always prevented in the event of a fire. In other words, the control unit according to the invention is configured as a priority circuit which suppresses the provision of the stop signal in the event of a fire. It is thus ensured that, if a fire event occurs during a pump test run, a reliable extinguishing agent supply is always ensured. This for the first time makes it possible to carry out a pump test run largely automatically. The control unit according to the invention is preferably adapted such that the suppression of the provision of the stop signal is suppressed at least during the pump test run. Further preferably, the control unit is adapted to suppress the provision of the stop signal for a given blocking time, which extends beyond the duration of the actual pump test run.

The control unit is preferably set up as a separate control unit which is installed in the water extinguishing system according to the invention in addition to a switch cabinet which is present in any case for controlling the water extinguishing system. It is also possible that the control unit according to the invention is designed to be integrated in the mentioned switch cabinet.

An expedient embodiment of the invention is characterised in that the water extinguishing system further comprises a fire alarm centre which is adapted to provide a fire alarm signal in the event of a fire, wherein the signal suppression unit is adapted to suppress the provision of the stop signal when a fire alarm signal has been provided. The fire alarm centre is advantageously adapted to establish by way of a plurality of fire detectors whether there is a fire event. If the fire alarm centre establishes that there is a fire event, it provides the fire alarm signal. Advantageously, the fire alarm centre is further configured to suppress the provision of the stop signal at least during the pump test run in order to reliably prevent the pump from being switched off in the event of a fire. A fire alarm center may also be referred to as a fire control unit.

A further expedient embodiment of the invention is characterised in that a flow detector is arranged between the supply line and the pipe system, which flow detector is adapted to cause the signal suppression unit to suppress the provision of the stop signal on detection of a volume flow of the extinguishing fluid through the flow detector. By means of the flow detector it is thus reliably recognised whether one or more sprinklers have already been opened by a fire event or not. If all the sprinklers or the alarm valve are in the closed state, the pump builds up a static pre-pressure in the supply line during a test run. In this case the volume flow through the flow detector is equal to zero.

If, however, one or more of the sprinklers or the alarm valve in the case of systems with open nozzles has/have opened as a result of a fire, extinguishing fluid flows from the supply line through the flow detector into the pipe system, so that the flow detector detects a volume flow that is other than zero. The above-described flow detector according to the invention is thus configured as a fire detection system by means of which the occurrence of a fire event is detected even during a pump test run and suppression of the stop signal is then initiated by means of the signal suppression unit. In this manner it is possible to reliably detect the occurrence of a fire event during an ongoing pump test run and to avoid stopping of the pump and thus always ensure a reliable continuous extinguishing agent fluid supply.

A further expedient embodiment of the invention is characterised in that the control unit comprises a pump start device, wherein the pump start device is configured to provide the start signal for starting the pump on detection of the volume flow by means of the flow detector. Preferably, a static pre-pressure is applied to the extinguishing fluid in the supply line for that purpose.

Thus, when one or more of the sprinklers or the alarm valve in the case of systems with open nozzles open(s) in the event of a fire, at least a minimum amount of the extinguishing fluid flows through the flow detector. As a result of the detected volume flow, the mentioned start signal for starting the pump is provided by means of the program start device. In this manner, the flow detector according to the invention fulfils a dual function. On the one hand, it is configured, during a pump test run, to detect the opening of one or more sprinklers in the event of a fire and to block switching off of the pump initially temporarily, and on the other hand it is adapted, when the pump is switched off and there is a static pre-pressure in the supply line, to reliably detect the opening of one or more of the sprinklers, or of the alarm valve in the case of systems with open nozzles, initiated by a fire event.

A preferred further development of the invention is distinguished in that the flow detector is configured to suppress the provision of the stop signal when the detected volume flow exceeds a given minimum volume flow. If the detected volume flow exceeds the value of the given minimum volume flow, this is a clear indication that a fire event has occurred. Switching off of the pump at the end of the pump test run is thus reliably avoided in the event of a fire and the extinguishing fluid supply is ensured.

According to a further preferred embodiment of the invention, the flow detector is configured as a flow switch. The flow detector is thus advantageously adapted to be particularly robust towards faults and faulty activation.

A further expedient embodiment of the invention is characterised in that the signal suppression unit comprises a first controllable electromagnetic switch having a controllable first working contact, wherein the stop signal is guided electrically via the first working contact in such a manner that the provision of the stop signal is suppressed, when a fire alarm signal has been provided, in that the first working contact opens. This offers the advantage that the suppression of the stop signal takes place on the hardware side. The suppression of the stop signal is thus provided by the circuitry and is free of further control-related components, in particular those which are computer program-based. Preferably, the suppression of the stop signal is thus additionally adapted to be redundant to the further control-related components. In this manner, it is achieved that the suppression of the stop signal is always ensured in the event of a fire, regardless of whether other control components, in particular those which are microprocessor-based, are functioning properly or not. Reliable suppression of the stop signal is thus always ensured in the event of a fire.

A further expedient embodiment of the invention is characterised in that the first controllable electromagnetic switch is adapted in such a manner that the provision of the stop signal is suppressed automatically, in the event of failure of the power supply, in that the first working contact opens automatically in the absence of a power supply. Thus it is advantageously always ensured, even in the event of a failure of the electric power supply, that the provision of the stop signal is reliably suppressed in every case. The suppression of the provision of the stop signal in accordance with the invention is thus unaffected if the power supply fails or is switched off.

A preferred further development of the invention is distinguished in that the signal suppression unit comprises a second controllable electromagnetic switch having a controllable second working contact, wherein the stop signal is guided electrically via the second working contact in such a manner that the provision of the stop signal is suppressed, on detection of the volume flow of the extinguishing fluid through the flow detector, in that the second working contact opens. This further development according to the invention has the advantage that, in addition to the above-mentioned measures for suppressing the stop signal, the second working contact additionally opens on detection of the volume flow.

According to a further preferred embodiment, the first working contact and the second working contact are connected in series. In this manner, the first working contact and the second working contact form an interrupt chain which is adapted to suppress the provision of the stop signal when only one of the two working contacts opens. In other words, the working contacts are in the form of a safety alarm chain via which the stop signal is guided. Opening of one or both of the working contacts always leads to suppression of the provision of the stop signal and ensures that the pump continues to operate in the mentioned cases.

According to a further preferred embodiment of the invention, the water extinguishing system comprises a central control unit which is adapted to initiate a pump test run in response to a manual input and/or automatically and which is configured to provide the start signal for initiating the pump test run and for starting the pump and to provide the stop signal for ending the pump test run and for stopping the pump.

The central control unit is preferably configured as a logic unit, for example as a programmable logic controller or the like, and forms a sub-unit of the control unit.

A preferred further development of the invention is distinguished in that the central control unit and/or the control unit is configured to suppress the provision of the stop signal in the event of a fire. For example, the provision of the stop signal is suppressed in the central control unit and/or the control unit by software. In conjunction with the above-mentioned embodiments of the signal suppression unit, the suppression of the provision of the stop signal is redundantly designed. In particular, it is thus ensured that, in the event of a failure or fault of the central control unit and/or of the control unit, the provision of the stop signal is at least always prevented in the event of a fire by means of the signal suppression unit, in order always to ensure the supply of extinguishing fluid.

According to a further preferred embodiment of the invention, the signal suppression unit is configured to be free of executing a computer program. In this manner, high reliability and constant functional capability of the signal suppression unit are ensured. To that end, the signal suppression is preferably carried out by means of analogue or digital circuits. Further preferably, the suppression is performed in a hard-wired manner by means of relay or protection combinations.

The object is further achieved by a corresponding method having the features mentioned at the beginning at least by temporarily suppressing the provision of the stop signal in the event of a fire by means of a signal suppression unit of the control unit, wherein the signal suppression unit is configured to be free of executing a computer program.

The object is further achieved by a corresponding method having the features mentioned at the beginning at least by temporarily suppressing the provision of the stop signal in the event of a fire by means of a signal suppression unit of the control unit.

The advantages achieved with the method according to the invention correspond to the benefits already mentioned above in connection with the water extinguishing system according to the invention. Therefore, in order to avoid repetition, only selected aspects of the method according to the invention will be discussed in detail here and in the following, the above advantages and embodiments mentioned in connection with the water extinguishing system according to the invention applying analogously also to the method according to the invention.

A preferred further development of the invention is distinguished by providing a fire alarm signal by means of a fire alarm centre in the event of a fire and suppressing the provision of the stop signal by means of the signal suppression unit when a fire alarm signal has been provided.

A further expedient embodiment of the invention is characterised by detecting a volume flow of the extinguishing fluid through a flow detector arranged between the supply line and the pipe system and causing the signal suppression unit to suppress the provision of the stop signal if a volume flow of the extinguishing fluid through the flow detector is detected by means of the flow detector.

A further expedient embodiment of the invention is characterised by providing the start signal for starting the pump if the volume flow is detected by means of the flow detector.

A further expedient embodiment of the invention is characterised in that the provision of the stop signal is suppressed by means of the flow detector if the detected volume flow exceeds a given minimum volume flow.

A preferred further development of the invention is distinguished by initiating a pump test run by means of a central control unit by manual input and/or automatically, comprising the steps: initiating the pump test run and starting the pump by provision of the start signal and optionally ending the pump test run to stop the pump by provision of the stop signal.

A further expedient embodiment of the invention is characterised by suppressing the provision of the stop signal in the event of a fire by means of the central control unit and/or the control unit.

### BRIEF DESCRIPTION OF THE DRAWINGS

Further preferred and/or expedient features and embodiments of the invention will become apparent from the description. Particularly preferred embodiments will be explained in greater detail with reference to the accompanying drawing. Both the water extinguishing system according to the invention and the method according to the invention are explained with reference to the drawings, in which:

FIG. 1 shows a schematic representation of the water extinguishing system according to the invention according to a first embodiment;

FIG. 2 shows a schematic representation of the water extinguishing system according to the invention according to a second embodiment;

FIG. 3 shows a schematic representation of the water extinguishing system according to the invention according to a third embodiment;

FIG. 4 shows a schematic representation of the water extinguishing system according to the invention according to a further embodiment;

FIG. 5 shows a circuit diagram of an embodiment of the signal suppression unit with the flow detector in the non-activated state; and

FIG. 6 shows a circuit diagram of the signal suppression unit with the flow detector in the activated state.

### DETAILED DESCRIPTION OF THE INVENTION

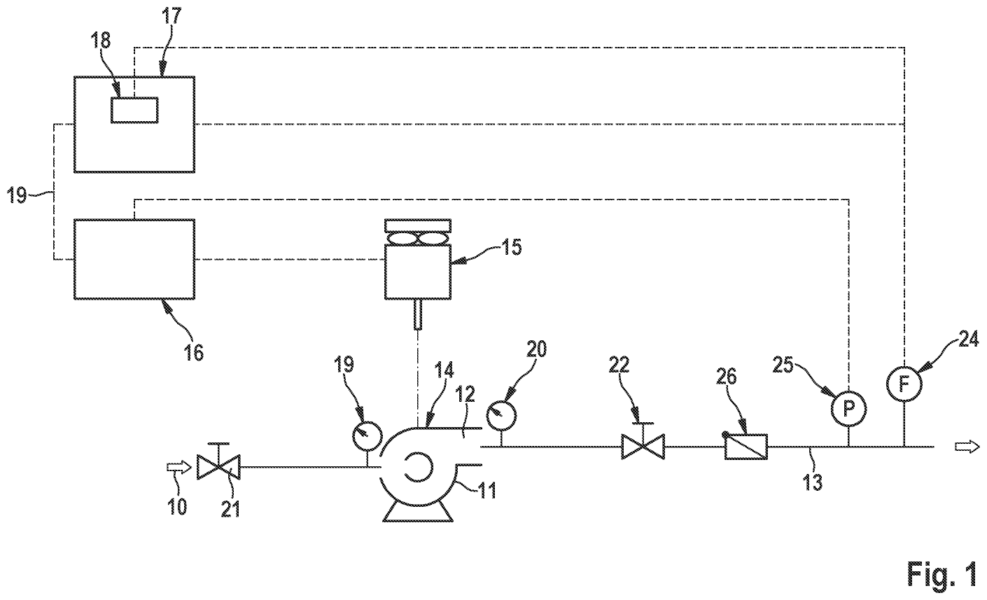

The water extinguishing system according to the invention and the method according to the invention are explained in detail hereinbelow with reference to FIG. 1.

The water extinguishing system according to the invention and the method comprise an extinguishing fluid supply 10, which is configured and adapted to provide an extinguishing fluid (not shown in the drawing). The extinguishing fluid supply 10 is in the form of, for example, an extinguishing fluid tank or extinguishing fluid supply line.

The water extinguishing system according to the invention further comprises at least one pump 14 which is adapted to convey the extinguishing fluid from the extinguishing fluid supply 10 into a supply line 12 to a pipe system 13 of the water extinguishing system. The pump 14 comprises an engine 15 which is preferably configured as a diesel engine or electric engine. Upstream of the engine 15 there is preferably provided an engine control unit 16, which is adapted to operate the engine 15 of the pump 14 in a controllably variable manner.

For the controllable operation of the pump 14 or of the engine 15, a control unit 17 is adapted to start and to operate the pump 14 for a pump test run on provision of a start signal and to end the pump test run and to stop the pump 14 on provision of a stop signal. Preferably, the control unit 17 provides the start and stop signal, which is processed by the engine control unit 16 in order to operate the engine 15 of the pump 14 in a controllably variable manner as described above.

The engine control unit 16 is adapted, according to the type of engine used, to start and to operate the engine 15. If the engine 15 is, for example, a combustion engine, such as, for example, a diesel engine, then the engine control unit 16 comprises the required electric starter as well as all the control components necessary for operation of the engine 15. In the case of the use of an electric engine or of a three-phase synchronous or asynchronous engine, the engine control unit 16 comprises, for example, a correspondingly programmed and configured frequency converter in order to perform the mentioned functions in a controllably variable manner.

According to the invention, the control unit 17 comprises a signal suppression unit 18 which is adapted to suppress the provision of the stop signal at least temporarily in the event of a fire. In other words, the signal suppression unit 18 is configured to prevent the stop signal from being transmitted to the control unit 17 during a fire, in order to prevent the pump 15 from being stopped in that case. Temporary suppression is to be understood as meaning that the suppression of the stop signal takes place for a predetermined minimum or blocking time or alternatively also permanently. Preferably, the stop and start signal are transmitted from the control unit 17 to the engine control unit 16 by means of a signal-carrying connection 19. The signal-carrying connection 19 is preferably in the form of a wired or wireless interface, for example a signal bus system.

Preferably, pressure gauges 19, 20 are provided on the suction side and on the pressure side of the pump 14, by means of which pressure gauges the pressure of the extinguishing fluid both on the suction side and on the pressure side of the pump 14 is measured and displayed. The pressure gauges 19, 20 are alternatively designed as pressure sensors. Further preferably, the suction side of the pump 14 is adapted to be shut off from the extinguishing fluid supply 10 by means of a first shut-off valve 21. On the pressure side of the pump 14 there is arranged a second shut-off valve 22 by means of which the pressure side of the pump 14 having the supply line 12 is adapted to be shut off from the pipe system 13.

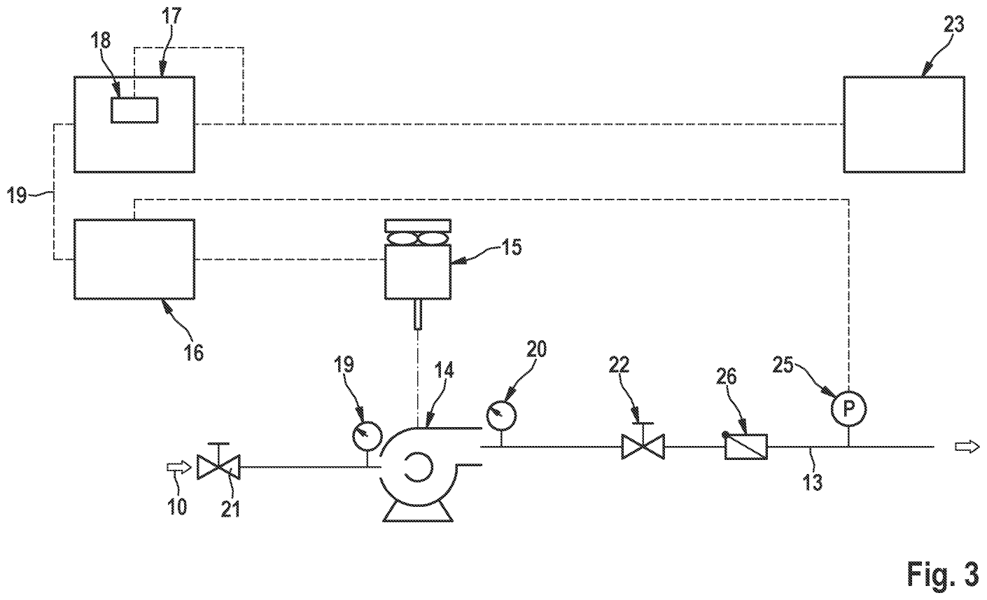

As is shown in FIG. 3, according to an expedient embodiment of the invention the water extinguishing system further comprises a fire alarm centre 23. The fire alarm centre 23 is adapted to provide a fire alarm signal in the event of a fire. The fire alarm centre 23 is in particular adapted to establish, via a plurality of fire detectors (not shown in the drawing), whether there is a fire event. If the fire alarm centre 23 detects such a fire event, it provides the fire alarm signal—as described above. The signal suppression unit 18 is adapted to suppress the provision of the stop signal when a fire alarm signal has been provided in order to reliably prevent the pump 14, or the engine 15, from being switched off in the event of a fire.

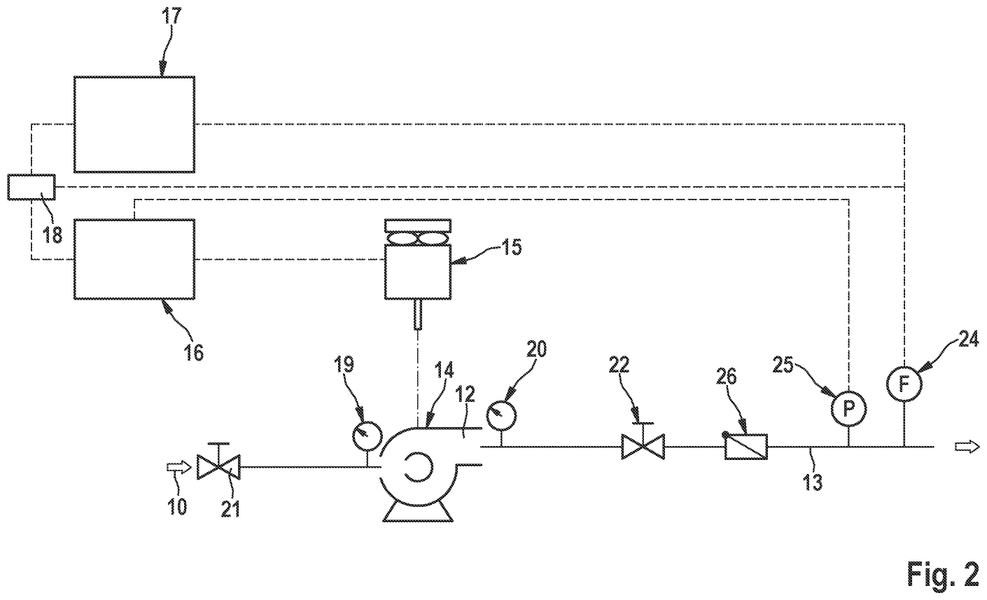

The signal suppression device 18 is preferably configured as an integral part of the control unit 17. The control unit 17 thus provides all the functionalities for controlling the engine 15, or the pump 14, including the above-described signal suppression. Alternatively, the signal suppression device 18 is designed as a separate unit—as shown schematically in FIG. 2.

Further preferably, a flow detector 24 is arranged between the supply line 12 and the pipe system 13. The flow detector is adapted to cause the signal suppression unit 18 to suppress the provision of the stop signal when a volume flow of the extinguishing fluid through the flow detector 24 is detected. The flow detector 24 is thus adapted to identify whether one or more of the sprinklers are already open as a result of a fire event or not. If all the sprinklers are in the closed state, then the pump 14 builds up a static pre-pressure in the supply line 12 during a test run in the extinguishing fluid supply 10. The volume flow through the flow detector 24 is in this case equal to zero.

In the event of a fire, with the sprinklers or alarm valves open, extinguishing agent flows from the supply line 12 through the flow detector 24 into the pipe system 13, so that the flow detector 24 detects a volume flow that is other than zero. In this manner it is possible to reliably identify the occurrence of a fire event during a pump test run and to prevent the pump 14 from being stopped, and thus always to ensure a reliable continuous extinguishing agent fluid supply.

A further expedient embodiment of the invention is characterised in that the control unit 17 comprises a pump start device (not shown in the drawing). The pump start device is configured to provide the start signal for starting the pump, for example on detection of the volume flow by means of the flow detector 24. Preferably, there is additionally connected to the pump start device a pressure sensor 25 or pressure switch 25. This is adapted to provide the start signal when a pressure drop is detected by the pressure sensor 25. A non-return valve 26 is preferably arranged between the supply line 12 and the pipe system 13.

A preferred further development of the invention is distinguished in that the flow detector 24 is configured to suppress the provision of the stop signal when the detected volume flow exceeds a given minimum volume flow. If the detected volume flow exceeds the value of the given minimum volume flow, this is a clear indication that a fire event has occurred. Switching off of the pump 14 or of the engine 15 at the end of the pump test run is thus reliably avoided and the extinguishing fluid supply is ensured in the case where a fire has been detected. According to a further preferred embodiment of the invention, the flow detector 24 is configured as a flow switch. The flow detector is thus advantageously particularly robust towards faults and faulty activation.

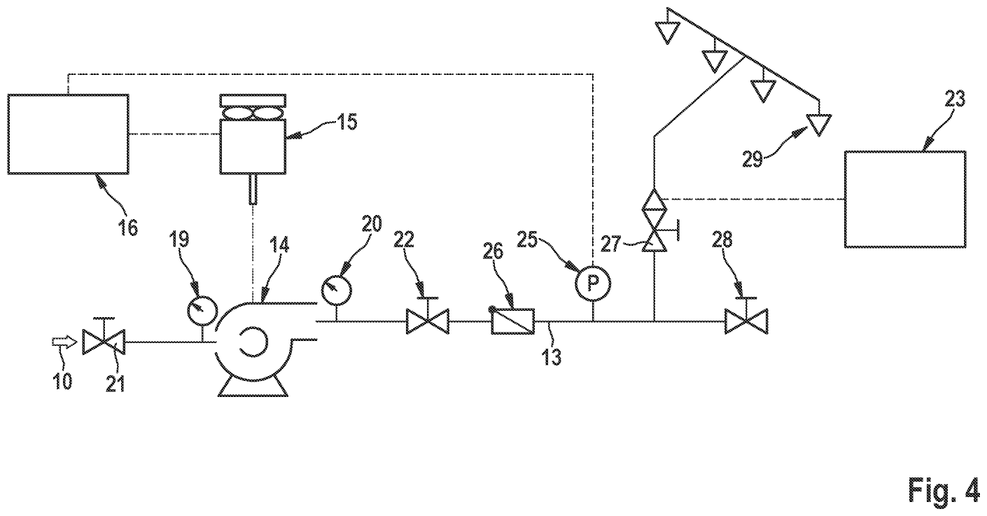

FIG. 4 shows a further embodiment variant of the embodiments already shown in FIGS. 1 and 2. Alarm valves 27, 28 are additionally shown in FIG. 4. The nozzles/sprinklers 29 which are shown, for example, are hydraulically connected to the alarm valve 27. The alarm valve 27 is coupled in terms of control with the fire alarm centre 23.

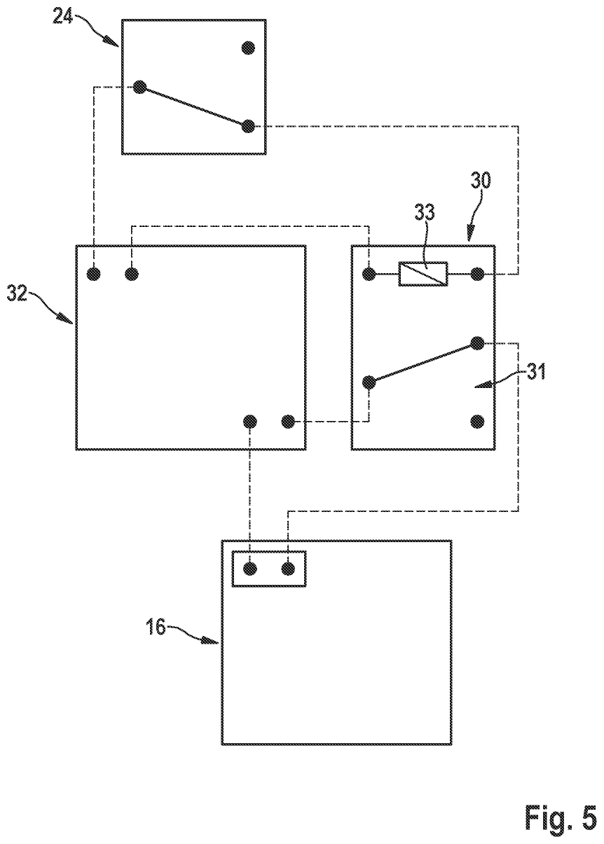

FIG. 5 shows a circuit diagram of the signal suppression unit 18, which is shown schematically as a simplified signal or circuit diagram. The signal suppression unit 18 is preferably configured as a first controllable electromagnetic switch 30 having a controllable first working contact 31. The stop signal is guided, for example, electrically via this first working contact 31 in such a manner that the provision of the stop signal is suppressed, when a fire alarm signal has been provided, in that the first working contact 31 opens.

In FIG. 5, the flow detector 24 is shown in the non-activated state, that is to say closed in the rest state. The stop signal which can be provided by a central control unit 32 is guided via the flow detector 24, for example, to the first controllable electromagnetic switch 30. As long as the flow detector 24 is electrically closed, the retaining coil 33 is supplied with current and the switch 30 guides a stop signal which may have been provided via the first working contact 31 to the engine control unit 16.

The central control unit 32 is configured in particular to initiate a pump test run in response to a manual input and/or automatically. The central control unit 32 is further configured and adapted to initiate the pump test run and to start the pump 14 by provision of the start signal and to end the pump test run and to stop the pump 14 by provision of the stop signal.

The central control unit 32 and/or the control unit 17 is preferably configured to suppress the provision of the stop signal in the event of a fire. In particular or according to the invention, the signal suppression unit 18 is configured to be free of executing a computer program.

The central control unit 32 is preferably configured as a logic unit, for example as a programmable logic controller or the like, and forms a sub-unit of the control unit 17.

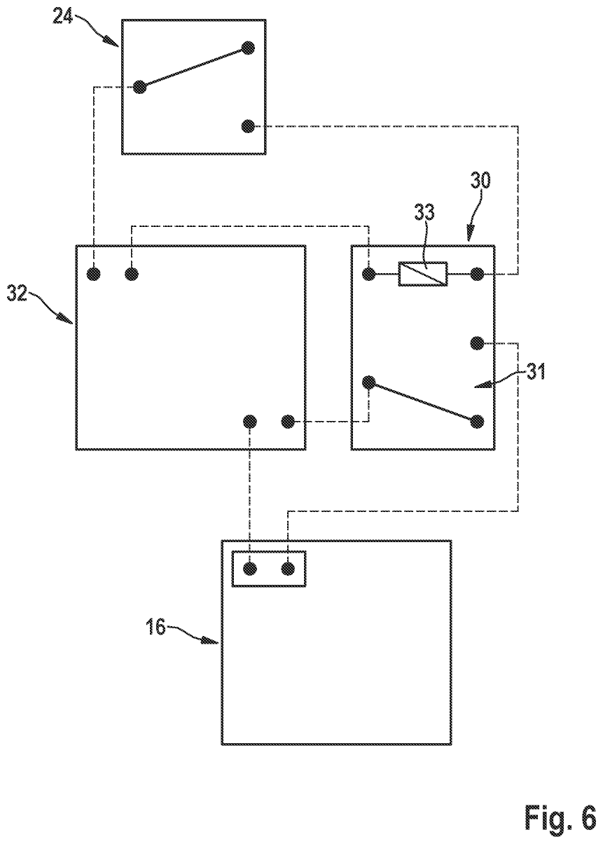

Further preferably, the first controllable electromagnetic switch 30 is adapted in such a manner that the provision of the stop signal is suppressed in a self-acting way, in the event of a failure of the power supply, in that the first working contact 31 opens in a self-acting way in the absence of a power supply. As is shown in FIG. 6, the retaining coil 33 is deenergised in the event of a failure of the power supply, so that the provision of the stop signal to the engine control unit 16 is suppressed.

Optionally, the signal suppression unit 18 shown only in FIGS. 1 to 3 comprises a second controllable electromagnetic switch (not shown in the drawing) having a controllable second working contact. The stop signal is guided electrically via the second working contact in such a manner that the provision of the stop signal is suppressed, on detection of a volume flow of the extinguishing fluid through the flow detector 24, in that the second working contact opens. The second working contact is alternatively formed by the flow detector 24 itself. The first working contact 31 and the second working contact are preferably connected in series.

FIG. 6 shows a circuit diagram of the signal suppression unit 18 but, in contrast to FIG. 5, with the flow detector 24 in the activated state. If the flow detector 24 opens, the supply voltage is withdrawn from the retaining coil 33, so that the first electromagnetic switch 30 is deenergised and the first working contact 31 opens, so that the provision of the stop signal is in any case interrupted in the event of a fire.

1. A water extinguishing system, comprising
an extinguishing fluid supply adapted to provide an extinguishing fluid;
at least one pump adapted to convey the extinguishing fluid from the extinguishing fluid supply into a supply line to a pipe system of the water extinguishing system;
a control unit adapted to operate the at least one pump in a controllable manner, which control unit is configured to start and to operate the pump for a pump test run on provision of a start signal and to end the pump test run and to stop the pump on provision of a stop signal;
wherein the control unit has a signal suppression unit which is adapted to at least temporarily suppress the provision of the stop signal in the event of a fire; and
a flow detector is arranged between the supply line and the pipe system, the flow detector being adapted to cause the signal suppression unit to suppress the provision of the stop signal on detection of a volume flow of the extinguishing fluid through the flow detector.

2. The water extinguishing system according to claim 1, further comprising a fire alarm centre which is adapted to provide a fire alarm signal in the event of a fire, wherein the signal suppression unit is adapted to suppress the provision of the stop signal when a fire alarm signal has been provided.

3. The water extinguishing system according to claim 1, wherein the control unit comprises a pump start device, the pump start device being configured to provide the start signal for starting the pump on detection of the volume flow by means of the flow detector.

4. The water extinguishing system according to claim 1, wherein the flow detector is configured to suppress the provision of the stop signal when the detected volume flow exceeds a given minimum volume flow.

5. The water extinguishing system according to claim 1, wherein the flow detector is configured as a flow switch.

6. The water extinguishing system according to claim 2, wherein the signal suppression unit comprises a first controllable electromagnetic switch having a controllable first working contact, wherein the stop signal is guided electrically via the first working contact in such a manner that, when a fire alarm signal has been provided, the provision of the stop signal is suppressed, in that the first working contact opens.

7. The water extinguishing system according to claim 6, wherein the first controllable electromagnetic switch is adapted in such a manner that, in the event of failure of a power supply, the provision of the stop signal is suppressed in a self-acting manner, in that the first working contact opens automatically in the absence of the power supply.

8. The water extinguishing system according to claim 6, wherein the signal suppression unit further comprises a second controllable electromagnetic switch having a controllable second working contact, wherein the stop signal is guided electrically via the second working contact in such a manner that the provision of the stop signal is suppressed, on detection of the volume flow of the extinguishing fluid through the flow detector, in that the second working contact opens.

9. Water extinguishing system according to claim 8, wherein the first working contact and the second working contact are connected in series.

10. The water extinguishing system according to claim 1, further comprising a central control unit which is adapted to initiate a pump test run in response to a manual input and/or automatically and which is configured to provide the start signal for initiating the pump test run and for starting the pump and to provide the stop signal for ending the pump test run and for stopping the pump.

11. The water extinguishing system according to claim 10, wherein the central control unit and/or the control unit are/is configured to suppress the provision of the stop signal in the event of a fire.

12. The water extinguishing system according to claim 1, wherein the signal suppression unit is configured to be free of executing a computer program.

13. A method for operating a water extinguishing system having an extinguishing fluid supply adapted to provide an extinguishing fluid, at least one pump adapted to convey the extinguishing fluid from the extinguishing fluid supply into a supply line to a pipe system of the water extinguishing system, and a control unit adapted to operate the at least one pump in a controllable manner, which control unit is configured to start and to operate the pump for a pump test run on provision of a start signal and to end the pump test run and to stop the pump on provision of a stop signal, the method comprising the following steps:
starting and operating the pump for the purposes of the pump test run by means of the control unit when a start signal has been provided;
ending the pump test run and stopping operation of the pump in the case where a stop signal has been provided;
at least temporarily suppressing the provision of the stop signal in the event of a fire by means of a signal suppression unit of the control unit;
detecting a volume flow of the extinguishing fluid through a flow detector arranged between the supply line and the pipe system; and
causing the signal suppression unit to suppress the provision of the stop signal if a volume flow of the extinguishing fluid through the flow detector is detected by means of the flow detector.

14. The method according to claim 13, further comprising:
providing a fire alarm signal by means of a fire alarm centre in the event of a fire; and
suppressing the provision of the stop signal by means of the signal suppression unit when a fire alarm signal has been provided.

15. The method according to claim 13, further comprising providing the start signal for starting the pump if the volume flow is detected by means of the flow detector.

16. The method according to claim 13, wherein the provision of the stop signal is suppressed by means of the flow detector if the detected volume flow exceeds a given minimum volume flow.

17. The method according to claim 13, further comprising
initiating the pump test run by means of a central control unit by manual input and/or automatically, comprising the steps:
initiating the pump test run and starting the pump by provision of the start signal; and
ending the pump test run to stop the pump by provision of the stop signal.

18. The method according to claim 13, further comprising suppressing the provision of the stop signal in the event of a fire by means of the central control unit and/or the control unit.

19. The method according to claim 13, wherein the signal suppression unit is configured to be free of executing a computer program.

20. A water extinguishing system, comprising:
an extinguishing fluid supply adapted to provide an extinguishing fluid;
at least one pump adapted to convey the extinguishing fluid from the extinguishing fluid supply into a supply line to a pipe system of the water extinguishing system;
a control unit adapted to operate the at least one pump in a controllable manner, which control unit is configured to start and to operate the pump for a pump test run on provision of a start signal and to end the pump test run and to stop the pump on provision of a stop signal;
wherein the control unit has a signal suppression unit which is adapted to at least temporarily suppress the provision of the stop signal in the event of a fire; and
the signal suppression unit is configured to be free of executing a computer program.

21. The water extinguishing system according to claim 20, further comprising a fire alarm centre which is adapted to provide a fire alarm signal in the event of a fire, wherein the signal suppression unit is adapted to suppress the provision of the stop signal when a fire alarm signal has been provided.

22. The water extinguishing system according to claim 20, further comprising a flow detector arranged between the supply line and the pipe system, the flow detector being adapted to cause the signal suppression unit to suppress the provision of the stop signal on detection of a volume flow of the extinguishing fluid through the flow detector.

23. The water extinguishing system according to claim 22, wherein the control unit comprises a pump start device, the pump start device being configured to provide the start signal for starting the pump on detection of the volume flow by means of the flow detector.

24. The water extinguishing system according to claim 22, wherein the flow detector is configured to suppress the provision of the stop signal when the detected volume flow exceeds a given minimum volume flow.

25. The water extinguishing system according to claim 22, wherein the flow detector is configured as a flow switch.

26. The water extinguishing system according to claim 21, wherein the signal suppression unit comprises a first controllable electromagnetic switch having a controllable first working contact, wherein the stop signal is guided electrically via the first working contact in such a manner that, when a fire alarm signal has been provided, the provision of the stop signal is suppressed, in that the first working contact opens.

27. The water extinguishing system according to claim 26, wherein the first controllable electromagnetic switch is adapted in such a manner that, in the event of failure of a power supply, the provision of the stop signal is suppressed in a self-acting manner, in that the first working contact opens automatically in the absence of the power supply.

28. The water extinguishing system according to claim 26, wherein the signal suppression unit further comprises a second controllable electromagnetic switch having a controllable second working contact, wherein the stop signal is guided electrically via the second working contact in such a manner that the provision of the stop signal is suppressed, on detection of the volume flow of the extinguishing fluid through the flow detector, in that the second working contact opens.

29. Water extinguishing system according to claim 28, wherein the first working contact and the second working contact are connected in series.

30. The water extinguishing system according to claim 20, further comprising a central control unit which is adapted to initiate a pump test run in response to a manual input and/or automatically and which is configured to provide the start signal for initiating the pump test run and for starting the pump and to provide the stop signal for ending the pump test run and for stopping the pump.

31. The water extinguishing system according to claim 30, wherein the central control unit and/or the control unit are/is configured to suppress the provision of the stop signal in the event of a fire.

32. A method for operating a water extinguishing system having an extinguishing fluid supply adapted to provide an extinguishing fluid, at least one pump adapted to convey the extinguishing fluid from the extinguishing fluid supply into a supply line to a pipe system of the water extinguishing system, and a control unit adapted to operate the at least one pump in a controllable manner, which control unit is configured to start and to operate the pump for a pump test run on provision of a start signal and to end the pump test run and to stop the pump on provision of a stop signal, the method comprising the following steps:
starting and operating the pump for the purposes of the pump test run by means of the control unit when a start signal has been provided;
ending the pump test run and stopping operation of the pump in the case where a stop signal has been provided;
at least temporarily suppressing the provision of the stop signal in the event of a fire by means of a signal suppression unit of the control unit;
wherein the signal suppression unit is configured to be free of executing a computer program.

33. The method according to claim 32, further comprising:
providing a fire alarm signal by means of a fire alarm centre in the event of a fire; and
suppressing the provision of the stop signal by means of the signal suppression unit when a fire alarm signal has been provided.

34. The method according to claim 32, further comprising:
detecting a volume flow of the extinguishing fluid through a flow detector arranged between the supply line and the pipe system; and
causing the signal suppression unit to suppress the provision of the stop signal if a volume flow of the extinguishing fluid through the flow detector is detected by means of the flow detector.

35. The method according to claim 34, further comprising providing the start signal for starting the pump if the volume flow is detected by means of the flow detector.

36. The method according to claim 34, wherein the provision of the stop signal is suppressed by means of the flow detector if the detected volume flow exceeds a given minimum volume flow.

37. The method according to claim 32, further comprising
initiating the pump test run by means of a central control unit by manual input and/or automatically, comprising the steps:
initiating the pump test run and starting the pump by provision of the start signal; and
ending the pump test run to stop the pump by provision of the stop signal.

38. The method according to claim 32, further comprising suppressing the provision of the stop signal in the event of a fire by means of the central control unit and/or the control unit.
